(19) United States
(12) Patent Application Publication
(10) Pub. No.: US 2009/0229516 A1
(43) Pub. Date: Sep. 17, 2009

(54) COMBINED MACHINE, PARTICULARLY FOR PAINTING SHEETS OF GLASS, CRYSTAL OR OTHER FLAT SURFACES IN GENERAL

(76) Inventors: Roberto SORBINI, Pesaro (IT); Fabrizio FILIPPINI, Pesaro (IT)

Correspondence Address: STITES & HARBISON PLLC, 1199 NORTH FAIRFAX STREET, SUITE 900, ALEXANDRIA, VA, 22314, US

(21) Appl. No.: 12/402,564

(22) Filed: Mar. 12, 2009

(30) Foreign Application Priority Data
Mar. 13, 2008 (IT) BO2008A000161

(51) Int. Cl. B05C 1/02; B05C 11/00

(52) U.S. Cl. 118/696; 118/223; 118/203

(57) ABSTRACT

The machine comprises a horizontal transfer line (2) formed by mutually parallel rubber-coated rollers underneath and tangent to a horizontal plane on which the sheet (L) to be processed travels, which sheet is advanced, by the rollers driven by suitable means (3, 4, 104, 5), in a predetermined and constant direction (F), two of these rollers (102, 202) being designed as opposing rollers for corresponding parallel applicator rollers (17, 19) above them, the latter rollers being driven by suitable means (18, 20) and having differing characteristics enabling them to perform two different painting operations, in one of which the applicator roller (17) rotates in the same direction and with the same speed of advance as the sheet, and in the other of which the applicator roller (19), also referred to as the reverse-type roller, rotates in the opposite direction to the direction of advance of the sheet and at an adjustable speed. The machine comprises: means to feed an appropriate amount of paint, ink or other product to said transfer rollers; comprises means (7-10) to control the misalignment of the opposing roller (102) of the reverse applicator roller (19) in order to adapt this pair of rollers to the processing of sheets of different thicknesses and/or characteristics, and comprises means to ensure that, depending on the painting process to be carried out, one of said two applicator rollers (17, 19) can be held in the low position of engagement with the sheet and can be activated, while the other applicator roller can be held in a high position of non-interference with said sheet and can be inactive.

The invention relates to machines for painting, on an industrial scale, sheets of glass, crystal or other flat surfaces in general. More specifically it relates to roller-type painting machines having at least one rubber-coated roller which engages with inking means and transfers the paint to the sheets which travel continuously on a horizontal conveyor. The continuity of this movement is the reason for the high hourly production rate of these machines.

Present-day roller-type painting machines for the industrial sector in question are fundamentally divided into two types, even though they have in common the use of a rubber-coated roller for transferring the paint to the surface which is to be decorated and engages with at least one parallel metal roller having a smooth, chrome-plated surface, this also being known as the metering roller, so as to define with the latter a trough into the middle of which paint is injected by feeder means for the painting process, which paint spreads under gravity all the way along the length of the applicator roller. At the ends of this trough, sealing means and/or means for draining off and collecting the excess paint are provided, and other means may then return the paint to the feed circuit. The machines also have means operating by a guide and slide or an eccentric to adjust the distance between the metering roller and the applicator roller and thereby vary the amount of paint transferred onto the latter roller and thence to the advancing glass sheet. The metering roller and applicator roller, with the regions which define the paint feed trough, both rotate towards the bottom of this trough. These two rollers are usually connected to each other by gearing.

In one type of painting machine, such as that described in U.S. Pat. No. 3,237,597, the applicator roller rotates in the same direction of advance as the glass sheet which advances on a belt conveyor or motorized rollers, with no relative movement occurring between the sheet and the applicator roller. The surface of the applicator roller is usually etched with lines of differing characteristics, depending on the type of paint to be applied, and this first type of machine, though suitable for applying covering paint, is more suitable for applying satin paint.

In a second type of painting machine, which is more suitable for applying covering paint and for so-called spreading operations, surface of the rubber-coated applicator roller may be microetched or smooth but in any case has differing characteristics from those of the applicator roller of machines of the first type indicated above. Painting machines of this second type, such as described for example in Japanese patent application JP61171569, are also known as reverse machines because their applicator roller rotates in the opposite direction to the direction of advance of the flat sheet, so that the amount of paint transferred to the sheet is correlated both with the amount of interference or distance between the applicator roller and the metering roller, and with the speed of rotation of this applicator roller, in direct proportion to this speed of rotation.

In this second type of machine, the glass sheet is conveyed by motorized rollers, and of these rollers that one which is placed against the applicator roller is positioned not with its shaft in the same vertical plane as that which also contains the axis of the applicator roller, but offset by a suitable amount downstream of this plane, the distance being adjustable as a function of the thickness of the glass sheet and of other parameters, to avoid fouling the incoming edge of the sheet which first passes underneath the applicator roller and only afterwards engages with the opposing roller.

On a production line, if both of the differing painting processes described above have to be carried out, with satin paint or with covering paint, at the present time the only option is to place two different machines of the above type one after the other. This creates problems of a large financial investment, excessive floor space requirements, and poor efficiency, since the two machines are used in alternation.

It is an object of the invention to overcome this problem of the prior art by means of a combined-type roller-type painting machine which has a floor space requirement little different to that of one of the two traditional machines, can be fitted into a processing line with a constant direction of advance of the sheets, and which can be quickly set up to be used for normal painting or reverse-type painting.

The combined machine according to the invention exploits the following idea for a solution. The machine has two applicator rollers with the differing characteristics described above and with the corresponding lower opposing rollers. Between the two applicator rollers there is preferably a common chrome-plated metering roller which can be moved by suitable means to engage with one or the other of said two applicator rollers, depending on the type of process to be performed. When one of the two applicator rollers is not in use, it does not rotate and is placed at a height of non-interference with the advancing glass sheet.

Other features of the invention and the advantages which it offers will become clearer in the course of the following description of a preferred embodiment thereof, illustrated purely by way of non-restrictive example in the figures of the appended sheets of drawings, in which:

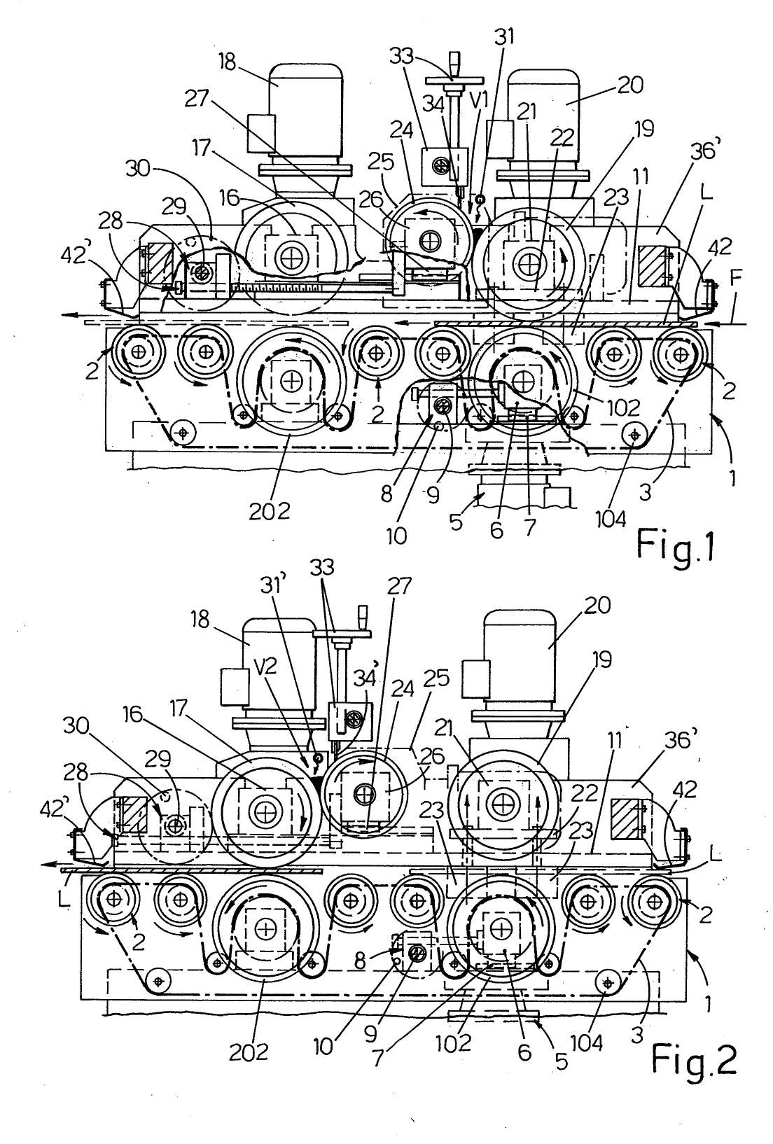

FIGS. 1 and 2 are partial views in side elevation of the machine seen in the two different working conditions;

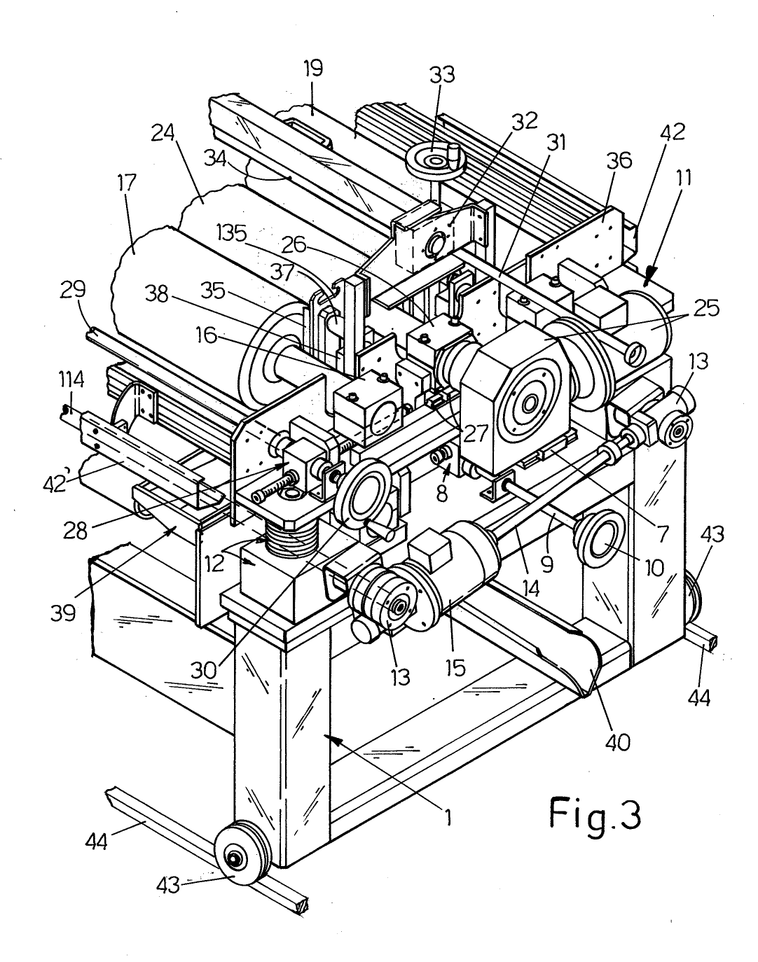

FIG. 3 is a partial perspective view of the machine in which one side, the top and the discharge front of the machine can be seen;

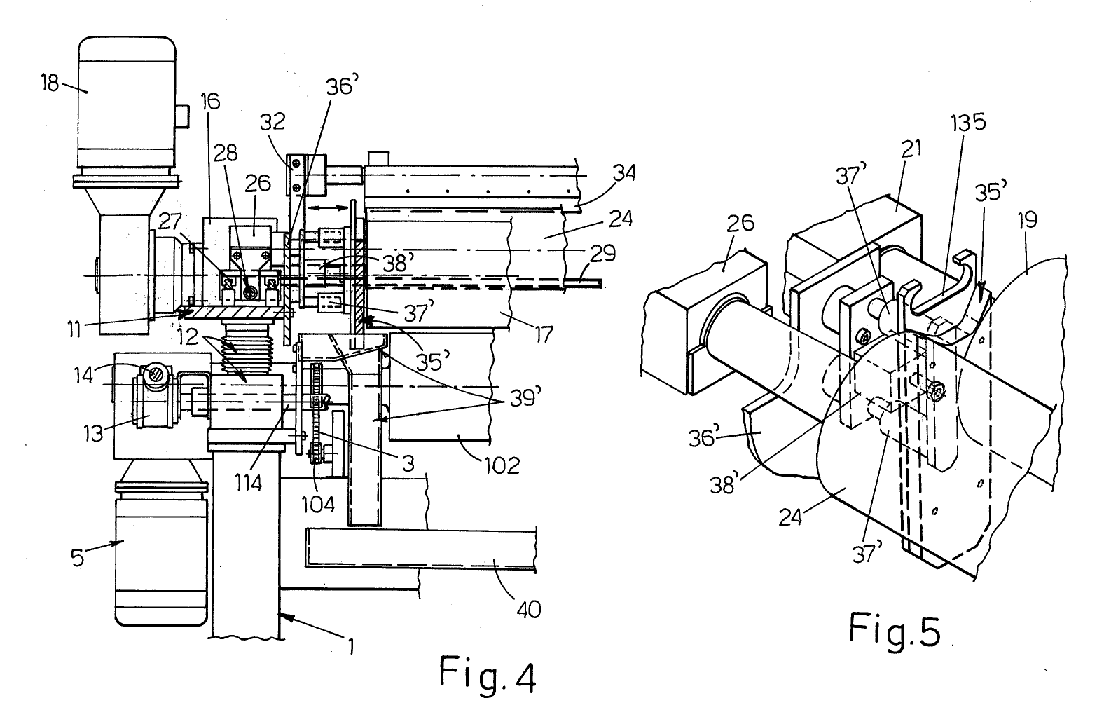

FIG. 4 is a partial front elevation view of the machine showing the opposite side of the same machine to that visible in FIG. 3;

FIG. 5 is a perspective view of one of the optional sealing means which close the ends of the paint holding troughs formed by the upper halves of the consecutive surfaces of the metering roller and an adjacent applicator roller;

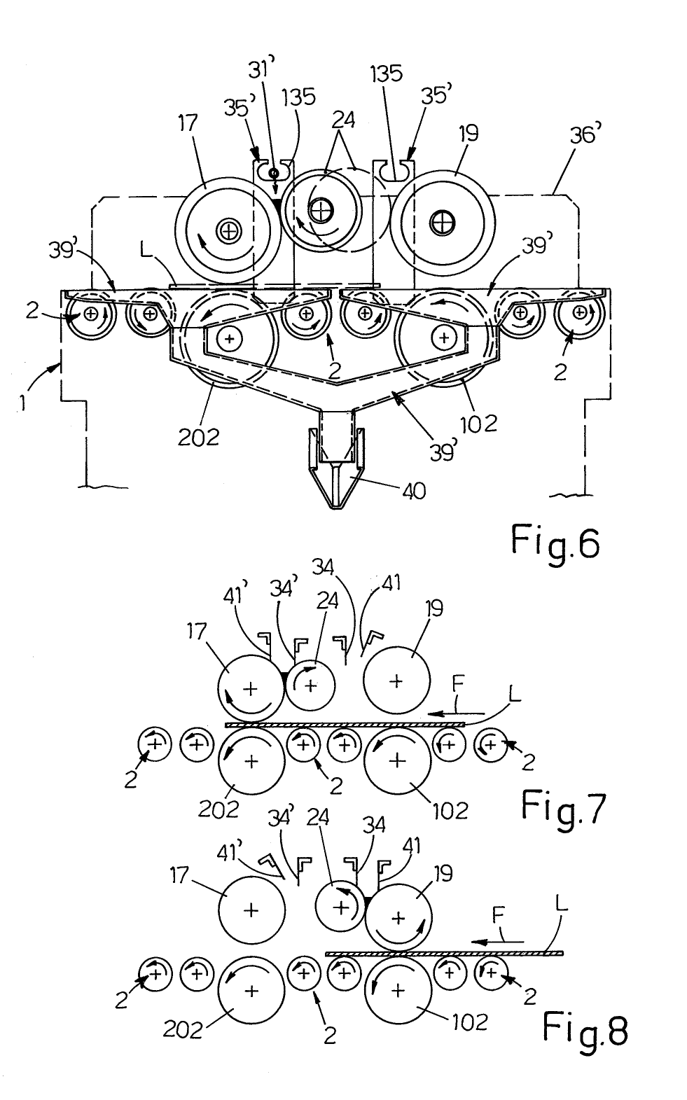

FIG. 6 is a schematic side view of the machine showing the parts seen in FIG. 5 and beneath them the hopper for collecting and discharging the paint that drains from said parts; and

FIGS. 7 and 8 are diagrams showing the machine in side elevation, with a possible arrangement on its squeegee cleaning rollers.

FIGS. 1 to 4 show the machine to comprise an understructure 1 whose sides support rotatably the ends of mutually parallel rollers whose bottom arcs are tangent to a horizontal plane on which the sheet L to be painted travels. The rollers 2 are preferably covered with rubber of suitable hardness, such as about 50SH, and are connected kinematically by at least one chain 3 and sprockets, some of which are keyed to one end of the shafts of said rollers 2 and some of which are idle, as indicated at 104, to act as return and tensioning means. Said sprocket and chain drive 3, 4 is such that the rollers 2 travel in the same direction and with the same peripheral speed, so that the sheet L to be painted advances along them for example in the direction indicated by arrow F, from right to left, without friction between it and these rollers.

Of said lower rollers 2, those marked 102 and 202 have a larger diameter than the others and act as opposing rollers for paint applicator rollers above them, as described later. One of these opposing rollers, for example roller 102, which is first to be contacted by the sheet L, is driven by a gearmotor 5 which, via the drive chain 3, 4 mentioned earlier, drives all the lower transfer roller system 2. Unlike all the other transfer rollers, roller 102 is also provided with means allowing it to be moved horizontally by an exact amount and then positioned eccentrically relative to the applicator roller above it, for known purposes which will be considered later. For this reason, the end brackets 6 of the shaft of the roller 102 are mounted on the understructure 1 via horizontal guide and slide means 7 and on each side of the understructure 1 there are linear motion actuators 8, such as screw and nut actuators, synchronized with each other by a shaft 9 which is parallel to the axis of the roller system 2 and can be turned precisely by a handwheel 10 shown more clearly in FIG. 3 and with motion display means (not shown).

Mounted in a horizontal arrangement on the understructure 1, with the possibility of vertical motion, is a platform or table 11, mounted on which are the applicator rollers and the metering roller which form the so-called paint application head, which because of the vertical motion referred to earlier can be adapted to the different thicknesses of the sheet L to be painted and to the differing working requirements, as explained later. Because of this need for vertical motion, the table 11 may for example be mounted on the understructure 1 via four vertical linear motion actuators of for example the screw and nut type, as indicated at 12, which may be actuated by three speed-reducing and angle-drive units 13 connected together by three synchronizing shafts 14 and 114 and driven by a gearmotor 15 in which the speed reducer forms the fourth of said angle speed reducers and whose motor has a through shaft, with two directions of rotation and of the type having electronic control of speed and phase, so that it can be remotely controlled through a programming, command and control panel, not shown here because it is obvious to those skilled in the art.

The rubber-coated applicator roller 17 is mounted rotatably about its axis with its end brackets 16 on the table 11 and lies parallel to its corresponding lower opposing roller 202, its function being to apply covering or satin paint. The surface of the elastomeric coating of the roller 17 may have a hardness of for example roughly 40SH and may be etched with lines which, depending on its intended use, may be around 26 lines per centimetre for applying covering paint, or around 60-80 lines per centimetre for applying satin paint. The axis of the roller 17 lies in a vertical plane which also contains the axis of the opposing roller 202 beneath it. The roller 17 is driven by a gearmotor 18 such that said applicator roller 17 can rotate on command with the same peripheral speed as the roller 202 and in the same direction F of advance as the sheet L.

Above and parallel to the opposing roller 102 is the rubber-coated roller 19 for the reverse-type application. Its elastomeric surface is similarly characterized by a hardness of around 40SH but, unlike the applicator roller 17 discussed above, it is ground smooth. The applicator roller 19 is driven by a gearmotor 20 which, when activated, turns it in the opposite direction to the direction F of advance of the sheet L with a velocity which can be varied electronically by means on said programming, command and control panel of the machine. The brackets 21 of the applicator roller 19 are mounted on bases 22 parallel to the table 11, which can on command be raised or lowered relative to said table by actuator means, e.g. of linear type, consisting for instance of pneumatic cylinder and piston units 23 mounted vertically by their body to the table 11 and mounted by their rods to the bases 22, there optionally being two for each base. This vertical motion will allow the reverse applicator roller 19 to be positioned so that its lower generatrix is on a horizontal plane a suitable distance below or above the lower generatrix of the downstream applicator roller 17, in such a way that the sheet L travelling along the roller conveyor 2 can be worked either by the reverse roller 19 or by the final roller 17, while the inactive applicator roller is suitably raised above this sheet L. It should be understood that the cylinders 23 can be replaced by other means and that the vertical control of the roller 19 can instead be achieved, not by a rectilinear movement, but by an oscillating movement; these details will be obvious to those skilled in the art, who will have no trouble carrying them out.

Also mounted on the upper table 11 is a metering roller 24 characterized by a smooth and usually chrome-plated surface and laid parallel to and in between the two applicator rollers 17 and 19. Linear motion means enable it to be placed with the correct amount of interference against either of the two applicator rollers 17, 19. The gearmotor 25 which turns the metering roller 24 has an electric motor with two directions of rotation and electronically controllable speed, so that the roller 24 can be set correctly to cooperate with applicator roller 17 or applicator roller 19.

The brackets 26 which rotatably support the ends of the shaft of the roller 24 are mounted on the table 11 via means 27 of horizontal linear motion parallel to the motion F of the sheet to be processed and the sliding of these means 27 is connected to linear motion actuators 28, which may for example be of the screw and nut type, their body being fixed to the table 11 and connected to each other by a shaft 29. The latter is parallel to said rollers and can be operated by for example a handwheel 30 and/or a precision servo command operated remotely through the command and control panel of the machine.

The operation of the machine, as far as the parts described thus far are concerned, is simple and obvious.

When the machine is to be used for applications with the reverse roller 19, the latter is in the low position and, by adjusting the height of the elevator table 11, the distance between this roller 19 and its opposing roller 102 is adjusted to suit the thickness of the sheet L to be processed. The applicator roller 19 is set up with an appropriate amount of interference with the sheet so that it exerts on the sheet an appropriate contact pressure, which is a known amount. In this case, and still in relation to the thickness of the sheet and to any other parameters, the opposing roller 102 will be shifted horizontally so that there is a suitable misalignment between the latter and the applicator roller 19 above it. In this phase, illustrated in FIG. 1, the applicator roller 17 is raised relative to the applicator roller 19 so that, besides being stationary because its motion unit 18 is off, the roller 17 is in a condition such as not to interfere in any way with the sheet L as it passes through.

The metering roller 24 is brought up to the reverse applicator roller 19 with the desired amount of interference, and the paint to be applied to the sheet below it is fed into the trough V1 formed by the upper halves of the consecutive surfaces of these rollers 19 and 24, e.g. into the middle of this trough, by at least one tube or other suitable means 31. Gravity and the rotating action of the rollers 19 and 24, the first of which rolls downwards while the other rolls upwards, spread the paint horizontally so that it fills the full length of the trough V1 (see later) and some of it is carried down by the roller 19 which then spreads it onto the sheet L as the latter advances in the direction of arrow F. The amount of paint transferred onto the sheet will depend on the relative speeds of the applicator roller 19 and the sheet L and also on the so-called amount of interference between the applicator roller and the sheet L and between the applicator roller and the metering roller 24.

Mounted on the elevator table 11, at the ends of the metering roller 24, are brackets 32 which support, with the possibility of differentiated positioning and adjustment, by screw and nut or other control means 33, at least one doctor blade 34 which is placed against the surface of the metering roller when it leaves the trough V1, before this surface reaches the highest point of this roller, in order to force all the paint which follows this roller in its rotation to fall into the trough V1. The doctor blades will be discussed more fully at a later point in the description.

When, on the other hand, the paint, which may for example be satin effect paint, is to be applied to the sheet L by the downstream applicator roller 17, the upstream applicator roller 19 is stationary and raised, as illustrated in FIG. 2. The metering roller 24 is placed against the applicator roller 17 with which it defines an upper trough V2 into which the paint is fed through a feed pipe 31′. The table 11 is set to the desired height so that the applicator roller 17 meets the upper face of the sheet L as it passes through, with an appropriate amount of interference.

In this case the applicator roller 17 draws paint from the bottom of the trough V2 and spreads it on the sheet L, keeping step with it as it advances in the direction F, without relative movements, other than those arising from the interference between the elastic surface of the roller 17 and the sheet L on its supporting opposing roller 202. In this situation the metering roller 24 is rotating in the opposite direction to the previous direction, so that its lateral surface is raised from the trough V2, while a doctor blade 34′ is then positioned on the left of this roller 24, to force paint following the roller 24 to fall into the trough V2. The amount of paint spread on the sheet L depends in this case on the amount of interference between the metering roller 24 and the applicator roller and on the amount of interference between this same applicator roller and the sheet L.

At the opposite ends of the two applicator rollers are vertical walls 35, 35′ supported by shoulders 36, 36′ attached to the elevator table 11, with intermediate pairs of guides and slides 37, 37′ parallel to the rollers and with respective interposed pneumatic cylinders 38, 38′ by means of which the walls are pushed as and when required into the active position in which they close the ends of the aforesaid troughs V1 and V2 in order to keep in the paint, especially when the paint is fed progressively in response to the amount progressively transferred to the sheets L. When the metering roller 24 is to be transferred from one position to the other, said walls are retracted so as not to interfere with the roller 24, and moved to the operating position after the metering roller has been correctly brought up to the associated applicator roller.

If, however, the paint is fed by a pump connected to the tubes 31, 31′, said walls 35, 35′ may be provided with a drainage channel open at the bottom, and, as illustrated in FIGS. 4 and 6, can discharge into hoppers 39, 39′ which drain into a single collecting channel 40 on a transverse slope to drain the excess paint into the same container as that from which the feed pump draws the paint. An equivalent solution to that described is shown by way of example in U.S. Pat. No. 3,237,597 cited in the introduction to the present document. The hoppers 39, 39′ (FIG. 6) have an elongate configuration that is also useful for collecting any paint that may drip from the edges of the applicator rollers and which stays on the latter due to the fact that they are not in contact underneath with the sheet. For this reason, one or more continuous or discontinuous, straight or inclined auxiliary doctor blades 41, 41′, as seen in FIGS. 7 and 8, may also be provided for appropriate cleaning of the applicator rollers 17, 19, or at least those parts of the surfaces of these rollers which engage with the feed troughs V1 or V2 but which do not engage with the sheet L.

It is clear in FIGS. 3, 5 and 6 that the walls 35, 35′ may end at the top in a fork shape, as indicated at 135, which is useful for resting the paint supply tube 31 or 31′, which will have an intermediate discharge or spaced-out discharge holes, so that this tube can easily be moved from one to the other of the troughs V1 and V2.

The machine is completed by protective guards 42, 42′ (FIGS. 1-3) at opposite ends, where the sheets L enter and exit from the machine. As FIG. 3 also shows, the understructure 1 can be supported by metal wheels 43 on a track 44 laid on the ground and means are provided to allow, if required, the entire machine to be moved laterally out of the processing line for greater convenience during periodic maintenance and/or for replacement of parts.

1. Combined machine, particularly for painting sheets of glass, crystal or other flat surfaces in general, characterized in that it comprises a horizontal transfer line (2) formed by mutually parallel rubber-coated rollers underneath and tangent to a horizontal plane on which the sheet to be processed travels, which sheet is advanced, by the rollers driven by suitable means (3, 4, 104, 5), in a predetermined and constant direction (F), two (102, 202) of said rollers (2) being designed as opposing rollers for corresponding parallel applicator rollers (17, 19) above them, the latter rollers being driven by suitable means (18, 20) and having different characteristics enabling them to perform two different painting operations, in one of which the applicator roller (17) rotates in the same direction and with the same speed of advance as the sheet, and in the other of which the applicator roller (19), also referred to as the reverse-type roller, rotates in the opposite direction to the direction of advance of the sheet and at an adjustable speed, means being provided to feed an appropriate amount of paint, ink or other product to the transfer rollers, and means (7-10) being provided to control the misalignment of the opposing roller (102) of the reverse applicator roller (19) in order to adapt this pair of rollers to the processing of sheets of different thicknesses and/or characteristics, and means being provided to ensure that, depending on the painting process to be carried out, one of said two applicator rollers can be held in the low position of engagement with the sheet and can be activated, while the other applicator roller can be held in a high position of non-interference with said sheet and can be inactive.

2. Machine according to claim 1, in which the two applicator rollers (17, 19) with the associated paint feed means are mounted on a common elevator table (11) positioned over the understructure (1) which supports the motorized sheet transfer rollers (2) with said opposing rollers (102, 202) and one of said applicator rollers (17, 19) being mounted on said elevator table and comprising interposed lifting and lowering means (23), in such a way that it can be moved to a lower or higher height than that of the other applicator roller, depending on whether this vertically movable applicator roller is to be used or not used in the painting process; the whole being so arranged that the interference between the applicator rollers and the sheet to be processed can be set using the same sole means which control the height of said elevator table (11).

3. Machine according to claim 2, in which said elevator table (11) is mounted for example on a supporting understructure (1) via four vertical linear motion actuators (12) of for example screw and nut type, which may be actuated by speed-reducing angle means (13) connected together by synchronizing shafts (14, 114) and driven by a gearmotor (15), the motor of which has two directions of rotation and is of the type having electronic control of speed and phase, so that it can be remotely controlled through a programming, command and control panel.

4. Machine according to claim 1, in which the means which provide for the necessary feeding of paint to either of said applicator rollers (17, 19) comprise, in a parallel arrangement between these applicator rollers, and mounted on said elevator table (11) with motion and control means (27-30), a common metering roller (24), usually chrome-plated, driven by its own motion means (25) comprising a motor with two directions of rotation and which can when required be placed against whichever of said two applicator rollers is active in the painting process, to form with this roller a respective trough (V1, V2) into which the paint can be fed for spreading on the sheets (L).

5. Machine according to claim 1, characterized in that vertical walls (35, 35′) are provided at the opposite ends of the two applicator rollers (17, 19) and are supported by shoulders (36, 36′) attached to the elevator table (11) with intermediate guide means (37, 37′) and with respective interposed actuators (38, 38′) consisting preferably of pneumatic cylinders, by which said walls are pushed as and when required into the active position in which they close the ends of said troughs (V1, V2).

6. Machine according to claim 5, comprising means such that when the metering roller (24) is to be transferred from one position to the other, said walls (35, 35′) can be retracted so as not to interfere with this roller and such that they can be moved to the operating position after this metering roller (24) has been correctly brought up to the associated applicator roller.

7. Machine according to claim 5, characterized in that the paint can be fed into said troughs (V1, V2) by a pump, in which case said walls (35, 35′) are fitted with a drainage channel to carry away excess paint into hoppers (39, 39′, 40) below them, from where said paint may for example be returned to the same container as that from which said feed pump draws the paint.

8. Machine according to claim 7, in which said hoppers (39, 39′) have a horizontally elongate configuration that is also useful for collecting any paint that may drip from the edges of the applicator rollers and which stays on the latter due to the fact that they are not in contact underneath with the sheet.

9. Machine according to claim 7, in which said walls (35, 35′) comprise a forked upper configuration (135) in such a way that the ends of the tube (31, 31′) connected to the pump feeding the paint to said troughs (V1, V2) can be positioned correctly on them.

10. Machine according to claim 5, characterized in that it comprises one or more doctor blades (34, 34′) for returning to the trough (V1, V2) paint which tends by contact to follow the metering roller (24) in its upward rotation.

11. Machine according to claim 10, characterized in that it comprises one or more continuous or discontinuous, straight or inclined auxiliary doctor blades (41, 41′), or equivalent means, for appropriately cleaning of said applicator rollers (17, 19), or at least for cleaning those parts of the surfaces of these rollers which engage with the feed troughs (V1, V2) but which do not engage with the sheet (L) below them.
